(19) United States
(12) Patent Application Publication
(10) Pub. No.: US 2011/0231200 A1
(43) Pub. Date: Sep. 22, 2011

(54) SYSTEM AND METHOD FOR LEAD MANAGEMENT AND LITERATURE DELIVERY

(75) Inventors: Dean Hills, Las Vegas, NV (US); William Kahn, Chicago, IL (US)

(73) Assignee: Hills-Kahn Inc. dba PRMconnect

(21) Appl. No.: 13/052,031

(22) Filed: Mar. 18, 2011

Related U.S. Application Data
(60) Provisional application No. 61/315,900, filed on Mar. 19, 2010.

(51) Int. Cl. G06Q 10/00

(52) U.S. Cl. 705/1.1

(57) ABSTRACT

A lead management and literature delivery system includes: a controller configured to: receive information identifying a user, the information received including electronic contact information; receive a selection of one or more electronic items to be provided to the identified user; electronically deliver the one or more selected electronic items to the user using the electronic contact information; assign a relationship between the identified user and a sales representative; and automatically notify the sales representative of the assigned relationship, information relating to the user identification and the electronic items delivered to the user.

### CROSS-REFERENCE TO RELATED APPLICATIONS

This application incorporates by reference and claims priority to U.S. Provisional Patent Application No. 61/315,900 filed Mar. 19, 2010.

### BACKGROUND OF THE INVENTION

The present subject matter relates generally to a lead management and literature delivery system. More specifically, the present invention relates to a lead management and literature delivery system wherein sales lead contact information is collected, literature is presented to the sales leads and the delivery and use of the delivered literature is tracked.

Exhibit show literature is a time consuming, costly and wasteful activity. Research shows that over 90% of all literature taken from an exhibit booth never leaves the attendee's hotel room. Moreover, hard copy literature can not be tracked, much less in real-time. Opportunities to collect sales lead information and deliver targeted content are often lost by presently known systems.

Accordingly, a need exists for a lead management and literature delivery system in which sales lead contact information is collected, literature is presented to the sales leads and the delivery and use of the literature is tracked.

### BRIEF SUMMARY OF THE INVENTION

The lead management and literature delivery system provided herein integrates the benefits of literature distribution, lead capture and activity tracking into a single system. The system eliminates the waste, dramatically lowers the costs and enhances the value of providing literature to potential customers.

In one contemplated example, the system uses a number of user interfaces, for example touch screen kiosks, located throughout an exhibition environment to deliver targeted content to the event attendees. The attendees log in to the kiosks by swiping their conference badges, or otherwise providing identifying information through the user interface.

By logging in, the users identify themselves to the system. That identification process and/or data stored and associated with the user's log in information includes the user's contact information. As described further herein, the log in process may be accomplished automatically through a variety of interfaced devices (e.g., magnetic stripe, barcode, RFID, business card reader, etc.) or through direct keyboard or touch-screen entry. Further, the log in process automatically gathers sales lead contact information. After logging in, the users may then browse the available literature in the system.

Through the system, a user (i.e., customer/potential sales lead) has the ability to browse and select any number of literature items to add to a personal “shopping cart.” When finished with the literature selection process, the system may present the user with any number of sales qualification and profiling questions that are triggered by the user's geographic region, the user's literature selections or pre-determined eligibility for certain types of questions. Once the user identifies literature to receive, the user can request an electronic copy (e.g., in PDF format) of that item to be sent directly to the user's email address.

The system is not limited by the number of user interfaces and does not need “live” internet connections on the event floor. The literature available to users may be controlled via a network based administration tool (for example, an Internet based administrative tool), which may enable an administrator to upload new/changed information, even during events.

The lead management and literature delivery system may provide the requested literature to the user by generating an email with a customized thank you note containing web links to the requested literature and a personalized thank you from the sales representative assigned to work with the specific user. The sales representative may be assigned, for example, based on a combination matrix of geography and product preferences determined by the selection of literature from the system.

Upon receiving the communication from the lead management and literature delivery system, the user can open and read any documents requested and delivered. The lead management and literature delivery system may prompt the user for further action. For example, the system may allow the user to instantly ask for additional information by filling out an integrated “Document Feedback” form. In addition the lead management and literature delivery system may allow the user to forward the specific document link or links on to an associate by filling out a “Forward to a Colleague” form.

The lead management and literature delivery system provided herein tracks, in real-time: the email delivery; whether the email was opened; how many times the email was opened; when the email was opened; whether the email was forwarded to an associate; whether those associates opened the literature; and enables users to run reports on this monitored activity at any time.

In addition to the features summarized above, the lead management and literature delivery system may include game/survey functionality. For example, the lead management and literature delivery system may provide an integrated or stand-alone survey system, which may incorporate a game element with a scoring feature to increase user participation and promote the collection of more valuable personal and demographic information, which cab be used to provide more customized and targeted service to the users. The game/survey system maybe adapted to handle the following aspects of lead gathering interactions: providing some entertainment value that engages the user with an interesting experience on several levels such as, entertainment, knowledge gathering, knowledge expansion, etc.; capturing and measuring a user's interest levels around products and offerings in addition to qualifying them in terms of their baseline knowledge and intentions so that they can be accurately placed in a sales funnel so follow-up activities are appropriate; and creating a qualification path that leads users toward an audience specific message or offer that is targeted to them based on their responses to the game/survey interactions.

Many companies have their customers segmented into a multitude of groupings. The survey/game tool allows the system to mold itself to fit the desires of each of those groups and provide them with a more personalized experience than a generic set of questions might. A sales force follow-up may then be based on or incorporate the knowledge gathered from this interaction to accelerate the sales conversation as the sale representative will no longer need to do discovery around a customer's interests and baseline knowledge base. The sales representative can jump directly into what is most important to the customer based on the known collected information.

With respect to the game elements of the system, in one example, the system may track individual user game scores based on a flexible scoring matrix that allows for enough granularities in scoring so many thousands of individuals can take the survey and still have enough scoring separation for individualized results. To accomplish this, the scoring system may use a linear algebraic equation that allows administrators to setup scoring guardrails for each individual game or survey. The game questions may take the form of true/false, Likert Scale, multiple choice, etc. and may be present in any number of forms such as, for example, dropdown list boxes, checkboxes, radio buttons, free form text entry, etc. The game aspects of the system may provide a score that can be used in a public display setting or as a data input point for measurement. For example, the system may have a leaderboard where high scores can be displayed to internal or external audiences. The leaderboard may calculate the results in real-time so the scores are always accurate and up to date.

In a contemplated embodiment of the game/survey, the system may provide a unique response for each possible answer, thereby increasing the targeting of the game/survey to the user. In other words, each unique answer may result in unique feedback, results or lead the user a different direction. For example, each question may handle an If/Then construct so that the system can easily branch to a different question or different survey construct at any time based on user input. Further, each question may have associated media for a given question/answer pair. For example, a given answer to a question may trigger video, Flash, HTML, image, audio, etc. In one embodiment, each answer to a question may trigger a function that allows users to see how their answers rate with all others that have answered that same question, for example, in a pie chart or similar visual representation. This chart maybe tabulated and created in real-time for up to date results each time the chart is generated.

The lead management and literature delivery system provided herein supports a plurality of collection events happening at any given time from anywhere on the globe. Each collection event generates and stores unique lead data in a format that allows for easy sorting and filtering. For example, sales lead data may be captured from all connected workstations in a central database in real-time. In some embodiments, the collected data may be exported to an associated CRM system or to a standard spreadsheet file format.

The document library and all other managed information associated with the information lead management and literature delivery system provided herein may be managed from via standard internet browsers, enabling system access from practically anywhere.

The lead management and literature delivery system provided herein helps to eliminate or reduce printing costs, shipping costs, paper waste and print lead times. The system integrates with CRM systems. It streamlines user interaction by incorporating lead contact information capture function, for example via badge or business card reader. Further, the system facilitates instant feedback from users, which may improve sales leads tracking and conversions.

In an example of the lead management and literature delivery system, the lead management and literature delivery system includes: a controller configured to: receive information identifying a user, the information received including electronic contact information; receive a selection of one or more electronic items to be provided to the identified user; electronically deliver the one or more selected electronic items to the user using the electronic contact information; assign a relationship between the identified user and a sales representative; and automatically notify the sales representative of the assigned relationship, information relating to the user identification and the electronic items delivered to the user.

An advantage of the lead management and literature delivery system provided herein is to provide a system that may be accessed by any device with a standards based browser.

Another advantage of the lead management and literature delivery system is in providing a system that allows unlimited events to run at the same time with different document libraries and qualification questions for each event and each device at each event.

A further advantage of the lead management and literature delivery system is to allow users to return to the system multiple times to access and/or forward the literature.

Another advantage of the lead management and literature delivery system is providing a system for consolidating user information into a single unified contact record.

Yet another advantage of the lead management and literature delivery system is in providing a system in which users may select specific literature for instantaneous electronic delivery.

A further advantage of the lead management and literature delivery system is that the system tracks literature delivery, opening and forwarding.

Another advantage of the lead management and literature delivery system is that the system may provide personalized customer profile/qualification questions adapted to each customer based on geography and/or product interest criteria.

Still another advantage of the lead management and literature delivery system is the system allows targeted users to be uploaded for quick identification of specific individuals.

A further advantage of the lead management and literature delivery system is that the system automatically connects customers with individual sales representatives and delivers personalized email greeting.

Yet another advantage of the lead management and literature delivery system is the system allows customers to read/download literature by clicking a link in an email communication.

Another advantage of the lead management and literature delivery system is the system allows customers to request more information at the same time as they are reading requested literature by clicking filling out an integrated feedback form.

Another advantage of the lead management and literature delivery system is the system automatically and instantly emails assigned sales representative when receiving a customer request for more information.

Still another advantage of the lead management and literature delivery system is that the system allows integration of rich media surveys (e.g., images, video, web content, etc.) and that the surveys may be delivered to individuals based on geographic location and product interest.

Yet another advantage of the lead management and literature delivery system is that the system may include an integrated survey/game system that encourages participation and provides a pathway for more individualized experience.

Another advantage of the lead management and literature delivery system is the system incorporates a video playback system to allow users to browse library of media clips and play them on-demand.

Another advantage of the lead management and literature delivery system is the system allows for extensive branding of user experience including logos, colors, backgrounds, fonts, verbiage.

A further advantage of the lead management and literature delivery system is the system allows unlimited users to manage the system and document library from anywhere in the world at any time.

Moreover, an advantage of the lead management and literature delivery system is the system features “real-time” tracking of requested literature; whether the customer receives it, opens it; forwards it and whether the forwarded contact opens it, and when, all in real-time.

It is still another advantage of the lead management and literature delivery system in that the system allows for easy integration of third party applications by sending contact, requests and other information details directly to those third party applications.

Another advantage of the lead management and literature delivery system is the system allows for non-linear process by allowing users to select their own experience.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a system for a lead management and literature delivery system.

FIG. 2 is a flow chart illustrating the steps of a method of providing a lead management and literature delivery system.

### DETAILED DESCRIPTION OF THE INVENTION

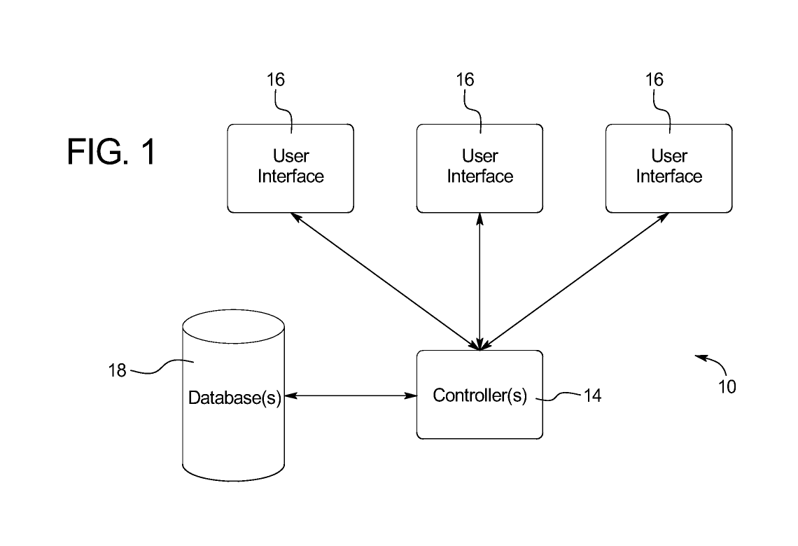

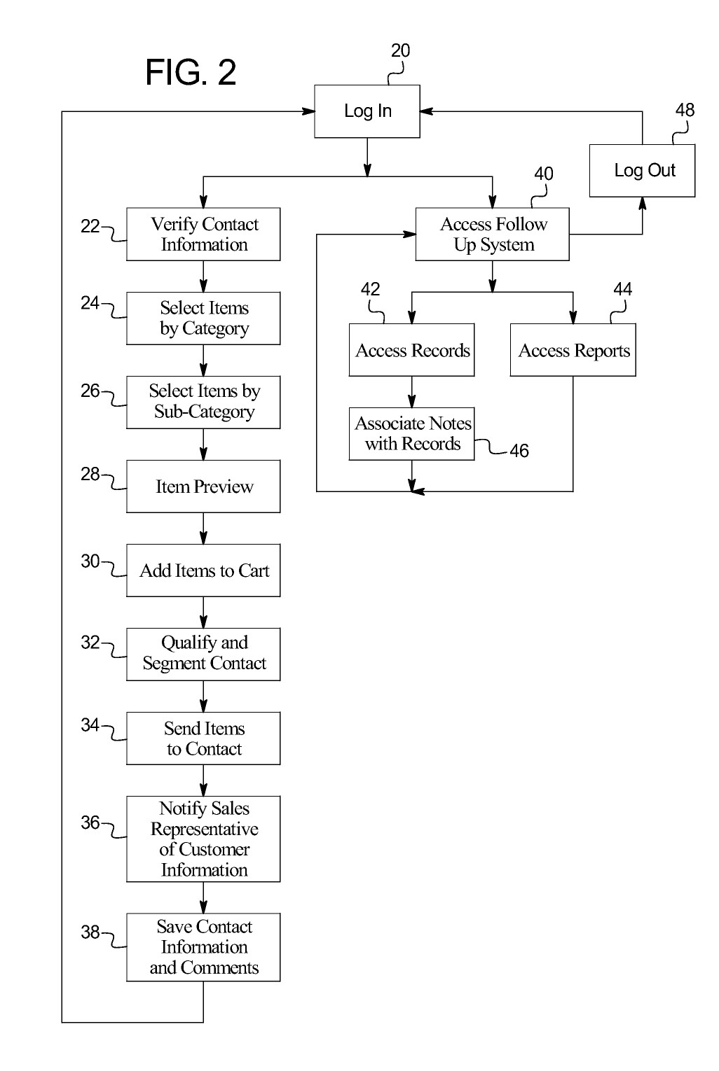

FIG. 1 illustrates a lead management and literature delivery system 10 (the system). FIG. 2 illustrates a method of providing a lead management and literature delivery system 12 (the method 12).

The lead management and literature delivery system 10 shown in FIG. 1 includes one or more controllers 14, a plurality of associated user interfaces 16 and one or more associated databases 18. The one or more controllers 14 run a variety of application programs, access and store data, and enable one or more interactions via the user interfaces 16 provided. While further description of the one or more controllers 14 is provided below, it is understood that the one or more controllers 14 may be embodied in any one or more electronic systems arranged to control the electronic aspects of the lead management and literature delivery system 10 and the method 12 described herein.

Users interact with the lead management and literature delivery system 10 via respective user interfaces 16. Accordingly, it is understood that there may be any number of user interfaces 16 that may be utilized by any number of users. Moreover, it is understood that each given user may access and interact with the lead management and literature delivery system 10 via a plurality of user interfaces 16. For example, a user may access the lead management and literature delivery system 10 a first time via a first user interface 16 and then access the lead management and literature delivery system 10 a second time via a second user interface 16. Moreover, numerous users may access the lead management and literature delivery system 10 simultaneously though any number of user interfaces 16.

As shown in FIG. 1, the lead management and literature delivery system 10 includes one or more databases 18. The one or more databases 18 store information relating to the operation of the lead management and literature delivery system 10 and method 12 as described herein. The one or more databases 18 may be integrated with the one or more controllers 14 or may be independent of the one or more controllers 14. The structure and operation of the one or more databases 18 will be understood to one having ordinary skill in the art given the context of the description provided herein. Further, for purposes of this disclosure, the phrase one or more databases 18 should be read to include any mechanism for storing, relating, organizing and retrieving data. It is also understood that in some contemplated embodiments of the lead management and literature delivery system 10 and method 12 the information storage and relationships may be inherent in the programming code, without the use of one or more databases 18.

The lead management and literature delivery system 10 may be a software-driven system. For example, the lead management and literature delivery system 10 may be a software-driven subscription based private network hosted on one or more servers functioning as the one or more controllers 14, as described herein. The database-driven software may provide a literature distribution, lead capture and activity tracking system. The lead management and literature delivery system 10 may be useful, for example, in distribution of product literature at events, such as trade shows.

Turning now to FIG. 2, a method 12 for implementing the lead management and literature delivery system 10 is illustrated. It is understood that the method 12 shown in FIG. 2 is merely one example of a method 12 used to implement a lead management and literature delivery system 10 as shown in FIG. 1.

As shown in FIG. 2, the method 12 includes a first step 20 of logging in to the system. The login in process may be accomplished by providing a log in screen to users via a user interface 16. The user may enter log in details through a keyboard, touch screen, by scanning a user badge or similar identification or otherwise provide log in information to the system 10. In one contemplated example, the users log in to the system 10 using mobile touch screen devices that receive log in information wirelessly through Bluetooth barcode scanners.

Further, it is understood that the step 20 of logging in may be accomplished by either a potential customer or a system administrator. For example, a potential customer (e.g., event attendee) may log in to the system 10 to access product literature, while a sales representative may log in to the system 10 to access records and reports as described further herein. Accordingly, the step 20 of logging in may include providing a mechanism for distinguishing between types of users, either by having separate log in processes, separate log in information or entirely different log in paths.

In the example shown in FIG. 2, the method 12 provides two log in processes to distinguish between potential customers and system administrators. For example, a potential customer logs in by swiping their conference badge (e.g., magnetic stripe, RFID tag, bar code, etc.), whereas a sales representative logs in by calling up a log in screen and entering an access code or other log in information.

The system 10 may be adapted such that the when used at an event, such as, a trade show or similar exhibition, attendees' registration information may be collected and stored in the system 10. Therefore, when an attendee logs in to the system 10, the stored information is accessed and associated with the user's activity within the system 10, as described further herein. Accordingly, when a user log in to the system 10, the log in information may be associated with contact and identification information and/or other demographic information. The system 10 may request the user confirm or edit the stored associated data via the step 22 of verifying contact information, as shown in FIG. 2. As a result, the log in process can be used to update and confirm the user's contact information.

After logging in and updating the contact and/or demographic information, a user may then select one or more items to receive, as shown in steps 24 and 26 in FIG. 2. The process of selecting one or more items to receive may include selecting items by category and subcategory, as shown in step 24 and step 26, respectively.

In the examples described herein, the items to be selected are product literature documents, often provided in PDF format or similar document exchange format. However, it is understood that the items may be any electronic files, including audio/visual items and other multimedia items.

Any number of categories and sub-categories of items may be provided and any number of associated steps may be used to browse, identify and/or select the items to be delivered to the user. For example, categories and sub-categories may be provided using subject matter tags. Alternative or supplementary keyword search tools may be provided for locating relevant items. Further, the available items may be provided alphabetically or in any other organized format.

Selection of the items may be accomplished by the user through the user interface 16, for example through a touch screen mechanism whereby the user selects items in step 26, may optionally preview the items selected in step 28 and may further add the selected items to the user's account for electronic delivery via step 30. The system 10 may use an electronic shopping cart or similar functionality to provide the user with a means for adding and removing items prior to final selection for delivery. The shopping cart or similar means may be provided in any format.

In addition to the selection of specific electronic items to be delivered to the user, the user may further be given the option to request to be contacted by a sales representative about a specific product, be added to a mailing list, provide feedback, etc. and may provide preferred method of contact or other relevant information. This may be implemented, for example, in a step 32 of qualifying and segmenting the contact (i.e., user). This step 32 enables the user to qualify himself or herself for appropriate contact by the company, sales representatives, etc. and can be a very useful tool for targeting permission based marketing, advertising and sales.

For example, the step 32 of qualifying and segmenting the contact may include registration for electronic newsletters, identification of preferred methods of contact and communication, any comments the user may have, etc.

As further shown in FIG. 2, the next step 34 includes sending the selected items to the contact. After the user selects the items to be delivered and qualifies himself or herself in step 32, the items are electronically delivered to the user at the email address associated with the contact information. Simultaneously with or subsequent to the delivery of the electronic items, the system 10 may notify an identified sales representative of the user's contact information, qualified information regarding how the client would like to be contacted and any other information the system 10 has gathered regarding the client and the client's activity in the system 10, as shown in step 36. Accordingly, the appropriate sales representative will be immediately informed of all relevant details and prepared to follow up with the prospective customer in the most appropriate manner.

For example, step 36 may include emailing an identified sales representative information including a notification that a new potential customer has been assigned to the sale representative, where and when the potential customer interacted with the system to receive the assignment, the potential customer's contact information and preferred contact method, the specific items requested by and delivered to the potential customer, as well as any additional qualification information provided by the potential customer in step 32 or otherwise provided through the system 10. The assignment of the sales representative to the potential customer may be completed automatically by the system 10 based on demographic data, customer interests, items selected for delivery and/or similar factors. For example, an automatic assignment might be made based on geography and items selected. In one contemplated example, the geographic data collected and sales representative assignment may be based on county level data, not just state or regional assignments. Alternatively, the sale representative assignment may be completed manually by a user in the system 10.

The final step in the method 12, when the system 10 is accessed by a potential customer, is the step 38 of saving of the contact information and comments into the database 18, further including the saving of any and all information collected via the user's interaction with the system 10. For example, the system 10 may collect information about the search terms used, the documents previewed and not added to the cart, etc. Any of the user's interactions with the system 10 may be monitored and saved for analysis or other purposes.

Finally, as shown in FIG. 2, after the information collected has been saved via step 38, the system 10 returns to the log in state, awaiting a new user to log in to the system 10.

As described above, in the example shown in FIG. 2, the method 12 provides two log in processes to distinguish between potential customers and system administrators. For example, a system administrator, such as, a sale representative may log in via step 20 and access the follow up system via step 40.

Once logged in to the follow up system, a user may access records via step 42 or access reports via step 44. Examples of records and reports that may be accessed through the system 10 are provided below.

The customer record may include any information collected from the customer, collected from the customer's interaction with the system 10, any notes regarding the user regarding the customer, any information provided by the event registration information and any other information concerning the customer, the customer's interactions with the system 10 and the customer's interest in the goods and services offered.

As further shown, after accessing records, the user may further associate notes with the records via step 46. For example, the system 10 may provide an interface through which a user may associates notes with the customer record, including follow up actions to be taken (schedule a demo, send literature, send partner program information, schedule a conversation, etc.), the type of follow up method to take (phone, email, etc.), qualitative analysis of customer interest (tire kicker, mildly interested, highly interested, etc.) and similar notes.

Numerous reports may be generated by the system 10 described herein. The reports may include any compilation or evaluation of the data collected and stored in the system 10. For example, the system 10 may provide a report illustrating the customers assigned to each sales representative. A contact and lead distribution and usage report may be provided that includes, for example, data segments and their related number of contacts, geographic demographics and similar information. Additional reports may be generated to illustrate the number of items requested, the number (or percentage) of those items that were opened or otherwise accessed by the requestor, the number of those items forwarded to further users, the number of times a particular user accessed or forwarded a particular item, number and/or percentage of contacts wanting further information or follow up contact, the number or percentage of contacts for whom there exist follow up notes, the number or percentage of users requesting or opting in to receive further communications, etc. There is no limit to the number and scope of the reports that may be developed and provided in the system 10.

After the sales representative completes the interaction with the follow up system, the sales representative may logout via step 48 and return the system 10 to the to the log in state, awaiting a new user to log in to the system 10.

The items selected by and provided to the users may be further adapted to collect additional information to be received by the system 10, stored in the database 18 and compiled and/or analyzed for the creation of reports, as described herein. For example, the items may be delivered via an email that includes one or more links to download the requested items. The electronic communication used to deliver the requested information (in the example used, the electronic communication is an email, though any electronic form of delivery may be used) may further include one or more mechanisms for prompting further user activity. For example, the electronic communication may include embedded electronic tools for requesting more information, providing feedback, forwarding the delivered content to other people, etc. In addition, the electronic tools may be setup to collect more contact and demographic information, such as, for example, information concerning the people to whom the content is forwarded. For example, a forwarding tool may enable a user to forward the item to another user, while enabling the system 10 to track the forwarding and delivery and capture additional information about the forwarded recipient.

All of the user interaction with the delivered items may be tracked and recorded by the system 10 including: monitoring when the electronic communication is sent, received, displayed, etc.; monitoring when the content is accessed, printed, forwarded, etc.; monitoring when and to whom the content is forwarded; monitoring whether additional information is requested; etc. This information may be collected, stored and analyzed to help improve the adaptation of materials for use in the system 10, for example, by determining which information sources lead to the most beneficial user actions or greatest user response.

As provided herein, in each of the steps shown in FIG. 2, the system 10 may collect and store information in the one or more databases 18. Moreover, in each of the steps above, instantaneous notification of activity within system 10 may be provided to one or more administrative users. For example, when users identified as “priority users” access the system, a sales representative may be alerted to directly contact the priority user (or may be notified of the priority user's location). All of this information may be monitored, recorded/stored and tracked in real-time and administrative users may run reports on this monitored activity at any time.

It is understood that various embodiments of the method 12 described herein may include any subset of the steps shown in FIG. 2 and described herein.

In another example, the lead management and literature delivery system 10 and method 12 may provide an integrated or stand-alone survey system, which may incorporate a game element with a scoring feature to encourage or increase user participation (a game/survey). The game/survey described herein may be presented as a part of the step of receiving user information 22 to assist in acquiring more information about the user or, alternatively, it may be presented as a stand-alone feature.

The game/survey maybe adapted to provide entertainment value and engage the user with entertainment, knowledge gathering, knowledge expansion, etc. The game/survey may be adapted to capture and measure a user's interest in products and offerings and qualify the user in terms of baseline knowledge and intentions. This information may be used to more accurately place the user in a sales funnel to promote more appropriate follow-up activities. The game/survey may be further adapted to create a qualification path that leads users toward an audience specific message or offer that is targeted to them based on their responses to the game/survey interactions.

Many companies have their customers segmented into a multitude of groupings. The survey/game tool allows the system 10 and method 12 to provide users with a more personalized experience than a generic set of questions might. For example, a sales representative may use the knowledge gathered from the game/survey to accelerate a future sales conversation by already having acquired information around a customer's interests and baseline knowledge base. The sales representative may jump directly into what is most important to the customer based on the information already collected by the system 10 and method 12.

With respect to the game elements of the system 10 and method 12, in one example, the system 10 may track individual user game scores based on a flexible scoring matrix that allows for enough granularities in scoring so many thousands of users can use the game/survey and still have enough scoring separation for individualized results. To accomplish this, the scoring system may use, for example, a linear algebraic equation that allows administrators to setup scoring guardrails. The game/survey questions may take any form, such as, for example, true/false, Likert Scale, multiple choice, etc. and may be present in any number of forms such as, for example, dropdown list boxes, checkboxes, radio buttons, free form text entry, etc. The game/survey provided by the system 10 and method 12 may provide a score that can be used in a public display setting or as a data input point for measurement. For example, the system 10 may present users with a leader board displaying high scores to internal and/or external audiences. The leader board results may be calculated in real-time so the scores are always accurate and up to date.

In a contemplated embodiment of the game/survey, the system 10 and method 12 may provide a unique response to each possible answer, thereby increasing the targeting or tailoring of the game/survey to the user. In other words, each unique answer may result in unique feedback, results or lead the user in a different direction. For example, each question may handle an If/Then construct to branch to a different question or different survey construct based on user input. Further, each question may have associated media for a given question/answer pair. For example, a given answer to a question may trigger an audio and/or visual response, using, for example, video, Flash, HTML, static images, audio, etc. In one embodiment, each answer to a question may trigger a function that allows users to see how their answers rate with all others that have answered that same question, for example, in a pie chart or similar visual representation. This chart maybe tabulated and created in real-time for up to date results each time the chart is generated.

As shown, in use, the lead management and literature delivery system 10 and method 12 described herein may be used to provide an online, subscription-based lead management and literature delivery system 10 for literature distribution, lead capture and activity tracking.

As described by the above discussion, aspects of the lead management and literature delivery system 10 are controlled by one or more controllers 14. As described above, the one or more controllers 14 run a variety of application programs, accesses and stores data, including accessing and storing data in associated databases 18, and enables one or more interactions via the user interfaces 16 provided. Typically, the one or more controllers 14 are implemented by one or more programmable data processing devices. The hardware elements operating systems and programming languages of such devices are conventional in nature, and it is presumed that those skilled in the art are adequately familiar therewith.

For example, the one or more controllers 14 may be a PC based implementation of a central control processing system utilizing a central processing unit (CPU), memories and an interconnect bus. The CPU may contain a single microprocessor, or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM, or the like. The system also includes mass storage devices such as various disk drives, tape drives, etc. In operation, the main memory stores at least portions of instructions for execution by the CPU and data for processing in accord with the executed instructions.

The one or more controllers 14 may also include one or more input/output interfaces for communications with one or more processing systems. Although not shown, one or more such interfaces may enable communications via a network, e.g., to enable sending and receiving instructions electronically. The physical communication links may be wired or wireless.

The one or more controllers 14 may further include appropriate input/output ports for interconnection with one or more output displays (e.g., monitors, printers, etc.) and one or more input mechanisms (e.g., keyboard, mouse, voice, touch, bioelectric devices, magnetic reader, RFID reader, barcode reader, business cardreader, etc.) serving as one or more user interfaces 16 for the controller 14. For example, the one or more controllers 14 may include a graphics subsystem to drive the output display. The links of the peripherals to the system may be wired connections or use wireless communications.

Although summarized above as a PC-type implementation, those skilled in the art will recognize that the one or more controllers 14 also encompasses systems such as host computers, servers, workstations, network terminals, and the like. In fact, the use of the term controller 14 is intended to represent a broad category of components that are well known in the art.

Hence aspects of the lead management and literature delivery system 10 and the method 12 discussed herein encompass hardware and software for controlling the relevant functions. Software may take the form of code or executable instructions for causing a controller 14 or other programmable equipment to perform the relevant steps, where the code or instructions are carried by or otherwise embodied in a medium readable by the controller 14 or other machine. Instructions or code for implementing such operations may be in the form of computer instruction in any form (e.g., source code, object code, interpreted code, etc.) stored in or carried by any readable medium.

As used herein, terms such as computer or machine “readable medium” refer to any medium that participates in providing instructions to a processor for execution. Such a medium may take many forms, including but not limited to, tangible storage media. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A lead management and literature delivery system comprising:
a controller configured to:
receive information identifying a user, the information received including electronic contact information;
receive a selection of one or more electronic items to be provided to the identified user;
electronically deliver the one or more selected electronic items to the user using the electronic contact information;
assign a relationship between the identified user and a sales representative; and
automatically notify the sales representative of the assigned relationship, information relating to the user identification and the electronic items delivered to the user.

2. The system of claim 1 wherein the information identifying the user is received, at least in part, via a barcode scanner.

3. The system of claim 1 wherein the information identifying the user is received, at least in part, via an RFID reader.

4. The system of claim 1 wherein the selection of one or more electronic items is made by a user through a touch screen interface.

5. The system of claim 1 wherein the controller is further configured to track the use of the one or more electronic items after delivery.

6. The system of claim 5 wherein the controller is configured to track the number of times the one or more electronic items are opened.

7. The system of claim 5 wherein the controller is configured to track the recipients to which the electronic items are forwarded.

8. The system of claim wherein the notification of the sales representative of the assigned relationship includes the notification of the user's receipt of one or more electronic items.

9. The system of claim 8 wherein the notification of the sales representative of the assigned relationship further includes the user's preferred contact details.

10. The system of claim 1 wherein the relationship assigned between the user and sale representative is based on geography.

11. A method of lead management and literature delivery comprising the steps of:
receiving information identifying a user, the information received including electronic contact information;
receiving a selection of one or more electronic items to be provided to the identified user;
electronically delivering the one or more selected electronic items to the user using the electronic contact information;
assigning a relationship between the identified user and a sales representative; and
automatically notifying the sales representative of the assigned relationship, information relating to the user identification and the electronic items delivered to the user.

12. The method of claim 11 further including the step of tracking the use of the one or more electronic items after delivery.

13. The method of claim 12 wherein the step of tracking the use of the one or more electronic items after delivery includes tracking the number of times the electronic items are opened.

14. The method of claim 12 wherein the step of tracking the use of the one or more electronic items after delivery includes tracking the recipients to which the electronic items are forwarded.

15. The method of claim 11 wherein the information identifying a user is received, at least in part, by reading information from a physical device.

16. The method of claim 15 wherein the physical device is an event badge.

17. The method of claim 16 wherein the event badge includes a barcode.

18. The method of claim 16 wherein the event badge includes an RFID element.
